(19) United States
(12) Patent Application Publication
(10) Pub. No.: US 2003/0124035 A1
(43) Pub. Date: Jul. 3, 2003

(54) Device for purification of the exhaust gases for an internal combustion engine

(75) Inventors: Christian Bert, Epinay S/Orge (FR); Marc Guyon, Arpajon (FR); Najat Moral, St. Michel Sur Orge (FR); Thierry Birchem, Paris (FR); Arno Fritz, Paris (FR); Catherine Hedouin, Gouvieux (FR); Thierry Seguelong, Puteaux (FR); Christophe Bouly, Valentigney (FR); Thierry Pontier, Montbeliard (FR); Christian Sarda, Dasle (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: RENAULT, Boulogne Billancourt (FR)

(21) Appl. No.: 10/179,242

(22) Filed: Jun. 26, 2002

Related U.S. Application Data
(63) Continuation of application No. 09/926,463, now abandoned.
Application No. 09/926,463 is a 371 of international application No. PCT/FR00/01038, filed on Apr. 20, 2000.

(30) Foreign Application Priority Data
May 7, 1999 (FR) 99 05843

(51) Int. Cl. B01D 53/56

(52) U.S. Cl. 422/171; 422/177

(57) ABSTRACT

A device for purification of exhaust gases of an internal combustion engine capable of achieving combustion of a fuel with lean air-fuel ratios. A NOx-adsorbing mechanism is installed in the exhaust line of the engine. That NOx-adsorbing mechanism can absorb the NOx present in the exhaust gases in the presence of excess oxygen and can release the absorbed NOx when the oxygen concentration of the exhaust gases decreases. The NOx-adsorbing mechanism does not contain any composition capable of acting as an NOx reduction catalyst, and especially no precious metal, and further a three-way catalyst is installed in the exhaust line downstream from the NOx-adsorbing mechanism.

The present invention relates to a device for purification of the exhaust gases of an internal combustion engine, and more particularly to a device for purification of exhaust gases comprising means for adsorbing the nitrogen oxides or NOx, or in other words an NOx trap, and a three-way or in other words trifunctional catalytic converter disposed downstream from the NOx trap.

In view of the need to reduce consumption by vehicles, the automobile industry is endeavoring to develop internal combustion engines capable of achieving combustion with lean air-fuel ratios (below the stoichiometric ratio). When such engines operate with lean carbureted mixtures, they are in fact capable of reducing fuel consumption and of limiting the emissions of CO₂ in the exhaust gases.

Nevertheless, such engines have the disadvantage that, while running on lean mixture, they generate nitrogen oxides or NOx, and this NOx absolutely must be removed before the exhaust gases are discharged to the atmosphere. The traditional “three-way” catalytic converter systems happen to require very strict proportions between the oxidizing agents and the reducing agents, and are therefore incapable of treating the NOx of exhaust gases by catalytic conversion when such exhaust gases contain excessive oxygen.

Exhaust-gas purification devices provided with NOx traps have been developed to overcome this problem. The principle of these devices, and especially of that described in European Patent EP 560991, is to adsorb the NOx produced when the engine is running on lean mixture.

Such NOx adsorption is achieved by passing the exhaust-gas stream emerging from the combustion chambers through a monolith impregnated with adsorbing substances. These substances are formed mainly from alkali metal or alkaline earth elements. The nitrogen oxides or NOx, oxidized beforehand to NO₂ by appropriate catalytic substances such as platinum, are adsorbed on the surface of the alkali metal or alkaline earth elements by formation of nitrates.

The storage capacity and life are necessarily limited, thus requiring that regenerations commonly known as purges must be performed periodically. They have the double objective of releasing the NOx trapped therein and of reducing the nitrogen oxides beforehand to nonpolluting compounds (nitrogen).

This purge stage takes place by virtue of an appropriate engine strategy designed to generate a medium having a low oxygen concentration and containing high concentrations of reducing agents (CO, H₂ or HC). Reduction of the NOx is then ensured by adding to the monolith a reducing function, often based on platinum or rhodium.

Although such exhaust-gas purification devices, by appropriate operation of the alternations between the adsorption phases and the so-called regeneration phases, can indeed achieve efficiencies compatible with the levels necessary to comply with legislative standards, they suffer from a certain number of disadvantages.

Effectively they require high levels of precious metals, since these precious metals participate in both the NOx storage and reduction reactions, and are therefore very expensive to make.

In addition, the current NOx traps are very sensitive to poisoning by sulfur dioxide (SO₂, formed from the sulfur initially present in the fuel). In fact, because of the presence of oxidation catalysts, the sulfur oxides replace the NOx oxides at the surface of the alkali metal and alkaline earth elements through a process very similar to that responsible for the formation of nitrates. The trapping activity then declines gradually in the course of time, and it is necessary to develop strategies for purging sulfur, which strategies result in high consumption of reducing agents and in particular of fuel.

The object of the present invention is therefore to remedy these disadvantages by developing an exhaust-gas purification device that ensures treatment of the NOx produced by running an engine on lean mixture and at the same time is not very costly and not very sensitive to sulfur poisoning.

The device according to the invention for purification of the exhaust gases of an internal combustion engine comprises an internal combustion engine capable of achieving combustion of a fuel with lean air-fuel ratios and NOx-adsorbing means installed in the exhaust line of the engine, these means being of the type that adsorb the NOx present in the exhaust gas in the presence of excess oxygen and that release the adsorbed NOx when the oxygen concentration of the exhaust gas decreases.

According to the invention, the purification device is characterized in that, on the one hand, the NOx-adsorbing means do not contain any composition capable of acting as NOx reduction catalyst, and especially no precious metal, and in that, on the other hand, a three-way catalyst is installed in the exhaust line downstream from the NOx-adsorbing means.

Another object of the invention is therefore to develop compositions that can be used to make NOx traps without using precious metals.

The objectives, aspects and advantages of the present invention will be understood more clearly by reading the description presented hereinafter of different embodiments of the invention, provided by way of non-limitative examples, while referring to the attached drawings, wherein:

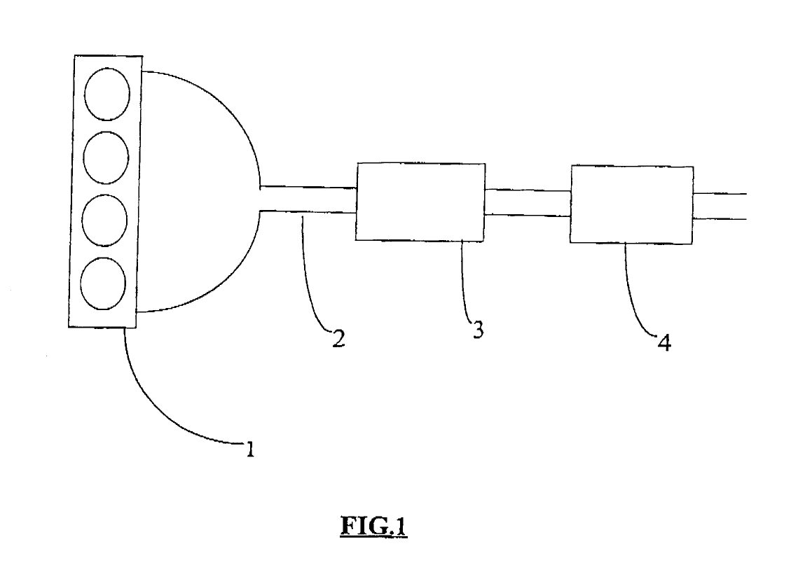

FIG. 1 is a schematic illustration of an internal combustion engine equipped with an exhaust-gas purification device according to the object of the present invention.

FIG. 1 illustrates an internal combustion engine 1 of multi-cylinder type. This engine, which can operate either by controlled ignition or by compression-induced ignition, is equipped with an electronic fuel-injection system, which is not shown. This device makes it possible in particular to control the richness of the carbureted mixture and thus that of the exhaust gases as a function of appropriate strategies.

From upstream to downstream in the direction of flow of the exhaust gases, exhaust line 2 of the engine is equipped with a NOx trap 3 and a three-way catalyst 4.

NOx trap 3 is characterized according to the invention in that it does not have any catalytic reduction efficiency. Thus the only function of this trap is to collect the NOx emitted when the engine is running on lean mixture and, once it is saturated, to release this NOx while the engine is running on rich mixture.

The nitrogen oxides released in this way are then reduced while passing through the three-way catalytic converter 4 disposed downstream.

Different formulations, all relying on the use of a support based on at least one oxide chosen from among the oxides of cerium, zirconium, scandium or rare earths and an active phase based on manganese, have been isolated in order to achieve the NOx trap according to the object of the present invention.

According to a first embodiment of the invention, the composition used to make NOx trap 3 is characterized in that it comprises a support based on an oxide of cerium, an oxide of zirconium and an oxide of scandium or of a rare earth other than cerium, and an active phase based on manganese and at least one other element chosen from among the alkali metals, the alkaline earths and the rare earths.

According to this first embodiment, the composition of the NOx trap comprises an active phase on a support.

More particularly, the active phase can exist in two alternative versions.

According to a first alternative version, this phase is based on an alkali metal and/or an alkaline earth in addition to manganese. The alkali metal can be more particularly sodium or potassium. The alkaline earth can be more particularly barium or strontium.

According to a second alternative version, the active phase is based on manganese and at least one element chosen from among the rare earths.

Here and throughout the entire description, rare earth is to be understood as elements of the group constituted by yttrium and the elements of the periodic table having atomic numbers between 57 and 71 inclusive.

The rare earth can be chosen more particularly from among lanthanum, cerium, praseodymium, neodymium, europium, samarium, gadolinium or terbium. As an advantageous embodiment within the scope of this second alternative version there can be cited an active phase based on manganese and praseodymium.

Finally, it is entirely possible, within the scope of this first embodiment, to have an active phase based on manganese and at least two other elements, one being a rare earth and the other being chosen from among the alkali metals and the alkaline earths.

The composition of this first embodiment can be obtained by a process in which at least one of the two elements manganese and potassium is introduced at least in part by potassium permanganate. It must be noted that only one element can be introduced by the permanganate, and only in part. On the other hand, and in preferred manner, it is also possible to introduce both elements in their entirety by the permanganate route. All other alternatives between these two possibilities can be envisioned. This embodiment makes it possible to obtain compositions having elevated NOx adsorption capacities.

Another important characteristic of the composition according to the object of this first embodiment is the nature of the support of the active phase.

As indicated hereinabove, the support is based on an oxide of cerium, an oxide of zirconium and an oxide of scandium or of a rare earth other than cerium. It is emphasized here and for the entire description that the invention is also applicable to any support based on cerium oxide, zirconium oxide and, as the third element, a combination of two or more oxides chosen from among scandium oxide and the rare earth oxides.

As supports there are preferably used those for which the cerium/zirconium atomic ratio is at least 1.

As rare earth contained in the composition of the support there can be mentioned more particularly lanthanum, neodymium and praseodymium.

There can also be used more particularly supports represented by the general formula CeₓZr_{y}M_{z}O₂, where M represents at least one element chosen from among the group comprising scandium and the rare earths other than cerium, and where x, y and z satisfy the conditions 0<z≦0.3, 1≦x/y≦19 and x+y+z=1.

More particularly, x, y and z can satisfy the following conditions, 0.02≦z≦0.2, 1≦x/y≦9, wherein the latter ratio can also be more particularly defined as between 1.5 and 4, these limits being inclusive.

According to an alternative version, the support has the form of a solid solution. In this case, the X-ray diffraction spectra of the support reveal the existence of a single homogeneous phase in the body of this support. For the supports richest in cerium, this phase corresponds in fact to that of a crystalline ceric oxide, CeO₂, whose lattice parameters deviate above or below those of a pure ceric oxide, thus reflecting the incorporation of zirconium and of the other element (scandium and rare earths other than cerium) into the crystal structure of cerium oxide, and thus the formation of a true solid solution.

According to a preferred alternative version of this first embodiment, there are used supports that are characterized by their specific surface area at certain temperatures as well as by their oxygen storage capacity.

By specific surface area there is understood the B.E.T. specific surface area determined by adsorption of nitrogen in conformity with ASTM Standard D 3663-78, which was established on the basis of the BRUNAUER-EMMETT-TELLER method as described in “The Journal of the American Society, 60, 309 (1938)”.

Thus there can be used supports having a specific surface area of at least 35 m²/g after 6 hours of calcining at 900° C. This surface area can be more particularly at least 40 m²/g. Even more particularly it can be at least 45 m²/g.

These supports can also have surface areas that are still large even after 6 hours of calcining at 1000° C. These surface areas can be at least 14 m²/g, more particularly at least 20 m²/g and even more particularly at least 30 m²/g.

Another characteristic of the supports of this alternative version is their oxygen storage capacity. This capacity, measured at 400° C., is at least 1.5 ml O₂/g. It can be more particularly at least 1.8 ml O₂/g and even more particularly at least 2 ml O₂/g. In the best cases, this capacity can be at least 2.5 O₂/g. This capacity is determined by a test that evaluates the capacity of the support or of the product successively to oxidize injected quantities of carbon monoxide with oxygen and to consume injected quantities of oxygen for reoxidation of the product. The method employed is known as the alternating method.

The carrier gas is pure helium at a flowrate of 10 l/h. The injections are made by means of a loop containing 16 ml of gas. The injected quantities of CO are obtained by using a gaseous mixture containing 5% of CO diluted in helium, while the injected quantities of O₂ are obtained from a gaseous mixture containing 2.5% of O₂ diluted in helium. The gases are analyzed by chromatography using a thermal conductivity detector.

From the quantity of oxygen consumed it is possible to determine the oxygen storage capacity. The characteristic value of the oxygen storage ability is expressed in ml of oxygen (under normal temperature and pressure conditions) per gram of product introduced, measured at 400° C. The measurements of the oxygen storage capacity given here and in the remainder of the description are made on products pretreated at 900° C. in air for 6 hours in a muffle furnace.

The supports of the composition which is the object of this first embodiment of the invention can be prepared in known manner. For example, they can be obtained from a solid/solid reaction of the oxides or of any other precursor, such as carbonates. They can also be prepared by a wet process, or in other words by using a base to precipitate salts of cerium, of zirconium and of the third element or elements, followed by calcining.

In the case of the preferred alternative version described hereinabove, and using supports defined by their specific surface areas and their oxygen storage capacity, the support can be obtained by a process in which there is prepared a mixture in liquid medium containing a compound of cerium, a compound of scandium or rare earth and a solution of zirconium, which is such that the quantity of base necessary to achieve the equivalence point during acid-base titration of this solution satisfies the molar ratio condition of OH⁻/Zr≦1.65; the said mixture is heated, the precipitate obtained is recovered and this precipitate is calcined.

The process for making the composition of the NOx trap which is the object of the first embodiment of the present invention will now be described in more detail.

The first stage of this process is to prepare a mixture in liquid medium, generally in aqueous phase, containing at least one compound of cerium, at least one compound of zirconium and one compound of scandium or of a rare earth. This mixture is prepared using a zirconium solution.

This zirconium solution can be obtained by the action of acid on a reagent containing zirconium. As appropriate reagent there can be cited the carbonate, hydroxide or oxide of zirconium. The action can be performed with an inorganic acid such as nitric acid, hydrochloric acid or sulfuric acid. Nitric acid is the preferred acid, and there can also be mentioned more particularly the use of a zirconyl nitrate obtained from the action of nitric acid on a zirconium carbonate. An organic acid such as acetic acid or citric acid can also be used.

This zirconium solution must exhibit the following characteristic. The quantity of base necessary to achieve the equivalence point during acid-base titration of this solution must satisfy the molar ratio condition OH⁻/Zr≦1.65. More particularly, this ratio can be at most 1.5 and even more particularly at most 1.3. In general, the specific surface area of the product obtained tends to increase as this ratio decreases.

The acid-base titration is performed in known manner. To perform it under optimal conditions, a solution adjusted to a concentration of about 3.10⁻² mole per liter, expressed as elemental zirconium, can be titrated. To this there is added with stirring a 1 N sodium hydroxide solution. Under these conditions, the equivalence point (change of pH of the solution) is clearly determined. This equivalence point is expressed by the OH⁻/Zr molar ratio.

As cerium compounds there can be cited especially the cerium salts such as the salts of cerium IV, such as nitrates or cerium ammonium nitrates, for example, which are particularly suitable here. Preferably ceric nitrate is used. The solution of cerium IV salts can contain cerium in the cerous state, but preferably it contains at least 85% of cerium IV. An aqueous solution of ceric nitrate can be obtained, for example, by reaction of nitric acid on a hydrated ceric oxide prepared in classical manner by reaction of a solution of a cerous salt, such as cerous nitrate, and an ammonia solution in the presence of hydrogen peroxide. There can also be used a ceric nitrate solution which is obtained by the process of electrolytic oxidation of a cerous nitrate solution such as described in French Patent A 2570087 and which can constitute an advantageous raw material.

It will be noted here that the aqueous solution of cerium IV salts can have a certain initial free acidity, for example a normality ranging between 0.1 and 4 N. According to the present invention, it is just as possible to use an initial solution of cerium IV salts that effectively has a certain free acidity as mentioned hereinabove as it is to use a solution that has been neutralized more or less completely beforehand by addition of a base, such as, for example, a solution of ammonia or even of hydroxides of alkali metals (sodium, potassium, etc.), but preferably a solution of ammonia, in order to limit this acidity. In this latter case it is then possible to define, in practical manner, a neutralization ratio (r) of the initial cerium solution by the following equation:

$$r = \frac{n3 - n2}{n1}$$

wherein n1 represents the total number of moles of Ce IV present in the solution after neutralization; n2 represents the number of moles of OH⁻ ions effectively necessary to neutralize the initial free acidity introduced by the aqueous solution of cerium IV salt; and n3 represents the total number of moles of OH⁻ ions introduced by the addition of the base. When the “neutralization” option is chosen, the quantity of base used absolutely must be smaller in all cases than the quantity of base that would be necessary to achieve complete precipitation of the hydroxide species Ce(OH)₄ (r=4). Thus the practical limit corresponds to neutralization ratios that do not exceed 1 and even preferably do not exceed 0.5.

The compounds of scandium or of rare earths are preferably compounds that in particular are soluble in water.

As compounds of scandium or of rare earths that can be used in the process under study, there can be cited, for example, the salts or inorganic or organic acids, for example of the sulfate, nitrate, chloride or acetate type. It will be noted that nitrate is particularly suitable. These compounds can also be introduced in the form of sols (suspensions). These sols can be obtained, for example, by neutralization of a salt of these compounds using a base.

The quantities of cerium, zirconium and rare earths or scandium present in the mixture must correspond to the stoichiometric proportions required to obtain a support having the desired final composition.

Once the initial mixture has been obtained in this way, it is then heated in conformity with the second stage of the process under study.

The temperature at which this heat treatment, also called thermohydrolysis, is performed can range between 80° C. and the critical temperature of the reaction medium, particularly between 80 and 350° C., preferably between 90 and 200° C.

Depending on the chosen temperature conditions, this treatment can be performed either under normal atmospheric pressure or under a pressure such as the saturated vapor pressure corresponding to the heat-treatment temperature. When a treatment temperature higher than the temperature of reflux of the reaction mixture is chosen (that is, generally higher than 100° C.), for example if a temperature of between 150 and 350° C. is chosen, the operation is then performed by introducing the aqueous mixture containing the aforementioned species into a sealed enclosure (closed reactor, better known as an autoclave), in which case the necessary pressure then results merely from heating the reaction mixture (self-generated pressure). Under the temperature conditions given hereinabove, and in aqueous media, it can therefore be stated, purely by way of illustration, that the pressure in the closed reactor varies between a value higher than 1 bar (10⁵ Pa) and 165 bar (165.10⁵ Pa), preferably between 5 bar (5.10⁵ Pa) and 165 bar (165.10⁵ Pa). Of course, it is also possible to apply an external pressure, which is then added to that achieved by heating.

Heating can be performed either under an atmosphere of air or under an atmosphere of inert gas, preferably nitrogen.

The treatment duration is not critical, and therefore can be varied within broad limits, such as between 1 and 48 hours, preferably between 2 and 24 hours.

At the end of the heating stage, a solid precipitate is recovered that can be separated from its medium by any classical solid-liquid separation technique such as filtration, decantation, suction filtration or centrifugation.

It may be advantageous after the heating stage to introduce a base such as an ammonia solution, for example, into the precipitation medium. This makes it possible to increase the yields of recovery of the precipitated species.

It is also possible to add hydrogen peroxide in the same way, after the heating stage.

The product as recovered can then be subjected to washing in water and/or in ammonia, at a temperature between room temperature and boiling point. To eliminate the residual water, the washed product can then be dried if necessary, in air, for example, at a temperature that can range between 80 and 300° C., preferably between 100 and 150° C., drying being continued until constant weight is reached.

It will be noted that it is of course possible, after recovery of the product and addition of the base or of the hydrogen peroxide if applicable, to repeat one or more times, in identical manner or otherwise, a heating stage such as described hereinabove, by then placing the product in liquid medium once again, especially in water, and performing, for example, heat-treatment cycles.

In a final stage of the process, the recovered precipitate is then calcined after any necessary washing and/or drying. According to a particular embodiment, it is possible, after the thermohydrolysis treatment and if necessary after the product has been placed in liquid medium once again and subjected to an additional treatment, to dry the obtained reaction medium directly by atomization.

Calcining is performed at a temperature of generally between 200 and 1200° C. and preferably between 300 and 900° C. This calcining temperature must be sufficiently high to transform the precursors to oxides, and it is also chosen as a function of the ultimate temperature of use of the support, while also taking into account the fact that the specific surface area of the product decreases as the calcining temperature used is increased. As regards the calcining time, it can be varied within broad limits, such as between 1 and 24 hours, preferably between 4 and 10 hours. Calcining is generally performed under air, but obviously calcining performed under inert gas, for example, is not excluded.

Deposition of the active phase on the support is performed in known manner. It can be achieved using an impregnation method. In this way there is first formed a solution or a slip of salts or of compounds of the elements of the active phase.

As examples of salts, there can be chosen the salts of inorganic acids, such as the nitrates, the sulfates or the chlorides.

There can also be used the salts of organic acids, and especially the salts of saturated aliphatic carboxylic acids or the salts of hydroxycarboxylic acids. As examples, there can be cited the formates, acetates, propionates, oxalates or citrates.

The support is then impregnated with the solution or the slip. After impregnation, the support is dried if necessary and then calcined. It must be noted that it is possible to use a support that has not yet been calcined prior to impregnation.

Deposition of the active phase can also be performed by atomization of a suspension based on salts or compounds of the elements of the active phase and of the support.

It may be advantageous to perform deposition of the elements of the active phase in two stages. Thus, in the case of active phases based on manganese and potassium and on manganese and praseodymium or vice versa, it may be advantageous to deposit the manganese and then the potassium in the first case and the praseodymium and then the manganese in the second case.

As indicated above, for the particular embodiment applied in the case in which the active phase comprises manganese and potassium, at least one of the elements manganese and potassium can be introduced, at least in part, by the potassium permanganate.

The contents of manganese, alkali metals, alkaline earths and rare earths can be varied within broad proportions. The minimal proportion is that beyond which NOx-adsorption activity is no longer observed. The proportions can range in particular between 2 and 50%, more particularly between 5 and 30%, these contents being expressed in % atomic relative to the sum of the elements of the support and of the elements in question of the active phase.

The compositions of the invention as described above have the form of powders intended to coat a support such as a monolith, but they can also be processed if necessary in such a way that they directly have the form of granules, balls, cylinders or honeycombs of variable dimensions.

According to a second embodiment of the invention, the present invention relates to a composition for a NOx trap based on manganese and its use for the treatment of exhaust gas.

According to a first alternative version, the composition according to this second embodiment contains manganese, cerium oxide or a mixture of cerium oxide and zirconium oxide, and it is characterized in that it additionally contains at least one other element chosen from among terbium, gadolinium, europium, samarium, neodymium and praseodymium.

According to a second alternative version, the composition according to this second embodiment contains manganese and potassium as well as cerium oxide or a mixture of cerium oxide and zirconium oxide, and it is characterized in that it can be obtained by a process in which at least one of the two elements manganese and potassium is introduced at least in part by the potassium permanganate.

The composition of the invention is characterized by the nature of the elements which it contains and which have been mentioned above. It will be noted here that, in this composition, the cerium oxide or the mixture of cerium oxide and zirconium oxide can form a support, while the other elements form a supported active phase. This means that the cerium oxide or the mixture of cerium oxide and zirconium oxide can constitute the majority element or elements of the composition on which element or elements the other elements are deposited.

For simplicity, the terms support and supported phase will be used in the description given hereinafter of this second embodiment, but it will be understood that cases in which an element is described as belonging to the supported phase is present in the support, for example because it was introduced therein during the very preparation of the support, are not beyond the scope of the present invention.

Within the scope of the first alternative version mentioned above, the composition can comprise a supported phase based on manganese in combination with terbium, gadolinium, samarium, neodymium or praseodymium or even on a mixture of manganese and at least two of these elements.

In the case of the second alternative version, the composition can comprise a supported phase based on manganese in combination with potassium. In addition, at least one of the two elements manganese and potassium is introduced at least in part by potassium permanganate in the course of the process of preparation of the composition. It must be noted that only one element may be introduced by the permanganate, and only in part. On the other hand, and in preferred manner, it is also possible to introduce both elements in their entirety by the permanganate route. All other alternative versions between these two possibilities can be envisioned. This embodiment makes it possible to obtain compositions having elevated NOx adsorption capacities.

The quantities of elements of the supported phase of the composition can be varied within broad proportions. The minimal proportion is that beyond which NOx-adsorption activity is no longer observed. Thus the proportions of manganese can be varied between 2 and 50%, more particularly between 5 and 30%. Those of terbium, gadolinium, samarium, neodymium, praseodymium and/or potassium can be varied between 1 and 50%, more particularly between 5 and 30%. These proportions are expressed in % atomic relative to the sum of the support and of the elements in question of the supported phase. It is pointed out here and for the entire description that manganese and the other elements are present in the form of oxides in the described compositions.

The supports based on cerium oxide or on a mixture of cerium oxide and zirconium oxide are well known. For the mixtures of cerium oxide and zirconium oxide there can be mentioned more particularly those described in European Patent Applications EP A 605274 and EP A 735984, the content of which is incorporated here. There can also be used more particularly the supports based on cerium oxide and zirconium oxide in which these oxides are present in a cerium/zirconium atomic ratio of at least 1. For these same supports, there can also be used those having the form of a solid solution. In this case, the X-ray diffraction spectra of the support reveal the existence of a single homogeneous phase in the body of this support. For the supports richest in cerium, this phase corresponds in fact to that of a crystalline cubic ceric oxide, CeO₂, whose lattice parameters deviate above or below those of a pure ceric oxide, thus reflecting the incorporation of zirconium into the crystal structure of cerium oxide, and thus the formation of a true solid solution.

According to other alternative versions of this second embodiment, there are used supports characterized by their specific surface area at certain temperatures as well as by their oxygen storage capacity.

Thus, there can be used supports based on an oxide of cerium and an oxide of zirconium in a cerium/zirconium atomic ratio of at least 1 and having a specific surface area of at least 35 m²/g after 6 hours of calcining at 900° C. Another characteristic of the supports of this alternative version is their oxygen storage capacity. This capacity, measured at 400° C., is at least 1.5 ml O₂/g. It can be more particularly at least 1.8 ml O₂/g. This capacity is determined by a test that evaluates the capacity of the support or of the product successively to oxidize injected quantities of carbon monoxide with oxygen and to consume injected quantities of oxygen for reoxidation of the product. The method employed is known as the alternating method.

The carrier gas is pure helium at a flowrate of 10 l/h. The injections are made by means of a loop containing 16 ml of gas. The injected quantities of CO are obtained by using a gaseous mixture containing 5% of CO diluted in helium, while the injected quantities of O₂ are obtained from a gaseous mixture containing 2.5% of O₂ diluted in helium. The gases are analyzed by chromatography using a thermal conductivity detector.

From the quantity of oxygen consumed it is possible to determine the oxygen storage capacity. The characteristic value of the oxygen storage ability is expressed in ml of oxygen (under normal temperature and pressure conditions) per gram of product introduced, measured at 400° C. The measurements of the oxygen storage capacity given here and in the remainder of the description are made on products pretreated at 900° C. in air for 6 hours in a muffle furnace.

In the case of the version described hereinabove and using supports defined by their specific surface areas and their oxygen storage capacity, the support can be obtained by a process in which there is prepared a mixture in liquid medium containing a compound of cerium and a solution of zirconium, which is such that the quantity of base necessary to achieve the equivalence point. during acid-base titration of this solution satisfies the molar ratio condition of OH⁻/Zr≦1.65; the said mixture is heated, the precipitate obtained is recovered and this precipitate is calcined.

The process for making this second embodiment will now be described in more detail.

The first stage of this process is to prepare a mixture in liquid medium, generally in aqueous phase, containing at least one compound of cerium and at least one compound of zirconium. This mixture is prepared using a zirconium solution.

This zirconium solution can be obtained by the action of acid on a reagent containing zirconium. As appropriate reagent there can be cited the carbonate, hydroxide or oxide of zirconium. The action can be performed with an inorganic acid such as nitric acid, hydrochloric acid or sulfuric acid. Nitric acid is the preferred acid, and there can also be mentioned more particularly the use of a zirconyl nitrate obtained from the action of nitric acid on a zirconium carbonate. An organic acid such as acetic acid or citric acid can also be used.

This zirconium solution must exhibit the following characteristic. The quantity of base necessary to achieve the equivalence point during acid-base titration of this solution must satisfy the molar ratio condition OH⁻/Zr≦1.65. More particularly, this ratio can be at most 1.5 and even more particularly at most 1.3. In general, the specific surface area of the product obtained tends to increase as this ratio decreases.

The acid-base titration is performed in known manner. To perform it under optimal conditions, a solution adjusted to a concentration of about 3.10⁻² mole per liter, expressed as elemental zirconium, can be titrated. To this there is added with stirring a

1 N sodium hydroxide solution. Under these conditions, the equivalence point (change of pH of the solution) is clearly determined. This equivalence point is expressed by the OH⁻/Zr molar ratio.

As cerium compounds there can be cited especially the cerium salts such as the salts of cerium IV, such as nitrates or cerium ammonium nitrates, for example, which are particularly suitable here. Preferably ceric nitrate is used. The solution of cerium IV salts can contain cerium in the cerous state, but preferably it contains at least 85% of cerium IV. An aqueous solution of ceric nitrate can be obtained, for example, by reaction of nitric acid on a hydrated ceric oxide prepared in classical manner by reaction of a solution of a cerous salt, such as cerous nitrate, and an ammonia solution in the presence of hydrogen peroxide. There can also be used a ceric nitrate solution which is obtained by the process of electrolytic oxidation of a cerous nitrate solution such as described in French Patent A 2570087 and which can constitute an advantageous raw material.

It will be noted here that the aqueous solution of cerium IV salts can have a certain initial free acidity, for example a normality ranging between 0.1 and 4 N. According to the present invention, it is just as possible to use an initial solution of cerium IV salts that effectively has a certain free acidity as mentioned hereinabove as it is to use a solution that has been neutralized more or less completely beforehand by addition of a base, such as, for example, a solution of ammonia or even of hydroxides of alkali metals (sodium, potassium, etc.), but preferably a solution of ammonia, in order to limit this acidity. In this latter case it is then possible to define, in practical manner, a neutralization ratio (r) of the initial cerium solution by the following equation:

$$r = \frac{n3 - n2}{n1}$$

wherein n1 represents the total number of moles of Ce IV present in the solution after neutralization; n2 represents the number of moles of OH⁻ ions effectively necessary to neutralize the initial free acidity introduced by the aqueous solution of cerium IV salt; and n3 represents the total number of moles of OH⁻ ions introduced by the addition of the base. When the “neutralization” option is chosen, the quantity of base used absolutely must be smaller in all cases than the quantity of base that would be necessary to achieve complete precipitation of the hydroxide species Ce(OH)₄ (r=4). Thus the practical limit corresponds to neutralization ratios that do not exceed 1 and even preferably do not exceed 0.5.

The quantities of cerium and of zirconium present in the mixture must correspond to the stoichiometric proportions required to obtain a support having the desired final composition.

Once the initial mixture has been obtained in this way, it is then heated in conformity with the second stage of the process under study.

The temperature at which this heat treatment, also called thermohydrolysis, is performed can range between 80° C. and the critical temperature of the reaction medium, particularly between 80 and 350° C., preferably between 90 and 200° C.

Depending on the chosen temperature conditions, this treatment can be performed either under normal atmospheric pressure or under a pressure such as, for example, the saturated vapor pressure corresponding to the heat-treatment temperature. When a treatment temperature higher than the temperature of reflux of the reaction mixture is chosen (that is, generally higher than 100° C.), for example if a temperature of between 150 and 350° C. is chosen, the operation is then performed by introducing the aqueous mixture containing the aforementioned species into a sealed enclosure (closed reactor, better known as an autoclave), in which case the necessary pressure then results merely from heating the reaction mixture (self-generated pressure). Under the temperature conditions given hereinabove, and in aqueous media, it can therefore be stated, purely by way of illustration, that the pressure in the closed reactor varies between a value higher than 1 bar (10⁵ Pa) and 165 bar (165.10⁵ Pa), preferably between 5 bar (5.10⁵ Pa) and 165 bar (165.10⁵ Pa). Of course, it is also possible to apply an external pressure, which is then added to that achieved by heating.

Heating can be performed either under an atmosphere of air or under an atmosphere of inert gas, preferably nitrogen.

The treatment duration is not critical, and therefore can be varied within broad limits, such as between 1 and 48 hours, preferably between 2 and 24 hours.

At the end of the heating stage, a solid precipitate is recovered that can be separated from its medium by any classical solid-liquid separation technique such as filtration, decantation, suction filtration or centrifugation.

It may be advantageous after the heating stage to introduce a base such as an ammonia solution into the precipitation medium. This makes it possible to increase the yields of recovery of the precipitated species.

It is also possible to add hydrogen peroxide in the same way, after the heating stage.

The product as recovered can then be subjected to washing in water and/or in ammonia, at a temperature between room temperature and boiling point. To eliminate the residual water, the washed product can then be dried if necessary, in air, for example, at a temperature that can range between 80 and 300° C., preferably between 100 and 150° C., drying being continued until constant weight is reached.

It will be noted that it is of course possible, after recovery of the product and addition of the base or of the hydrogen peroxide if applicable, to repeat one or more times, in identical manner or otherwise, a heating stage such as described hereinabove, by then placing the product in liquid medium once again, especially in water, and performing, for example, heat-treatment cycles.

In a final stage of the process, the recovered precipitate is then calcined after any necessary washing and/or drying. According to a particular embodiment, it is possible, after the thermohydrolysis treatment and if necessary after the product has been placed in liquid medium once again and subjected to an additional treatment, to dry the obtained reaction medium directly by atomization.

Calcining is performed at a temperature of generally between 200 and 1200° C. and preferably between 300 and 900° C. This calcining temperature must be sufficiently high to transform the precursors to oxides, and it is also chosen as a function of the ultimate temperature of use of the support, while also taking into account the fact that the specific surface area of the product decreases as the calcining temperature used is increased. As regards the calcining time, it can be varied within broad limits, such as between 1 and 24 hours, preferably between 4 and 10 hours. Calcining is generally performed under air, but obviously calcining performed under inert gas, for example, is not excluded.

It will be noted that, in the case of a support based on cerium oxide, it is possible to use a support that comprises, in addition to cerium oxide, a specific surface area stabilizer chosen from among the group of rare earths. By rare earth there is understood the elements of the group constituted by yttrium and the elements of the periodic table having atomic numbers between 57 and 71 inclusive. The rare earth can be more particularly praseodymium, terbium or lanthanum. It is to be noted that in this way it is possible to obtain a composition according to the invention that contains a rare earth both in the supported phase and in the support.

In the process of preparation of compositions of the invention comprising a support and a supported phase, deposition of the supported phase of the support is performed in known manner. It can be achieved using an impregnation method. In this way there is first formed a solution or a slip of salts or of compounds of the elements of the active phase.

As examples of salts, there can be chosen the salts of inorganic acids, such as the nitrates, the sulfates or the chlorides.

There can also be used the salts of organic acids, and especially the salts of saturated aliphatic carboxylic acids or the salts of hydroxycarboxylic acids. As examples, there can be cited the formates, acetates, propionates, oxalates or citrates.

The support is then impregnated with the solution or the slip. After impregnation, the support is dried if necessary and then calcined. It must be noted that it is possible to use a support that has not yet been calcined prior to impregnation.

Dry impregnation is used more particularly. In dry impregnation, a volume of an aqueous solution of the element equal to the pore volume of the solid to be impregnated is added to the product to be impregnated.

In the case of the second alternative embodiment described hereinabove, potassium permanganate is of course used as salt of manganese and potassium. If necessary, the make-up quantity of manganese and/or potassium can be introduced by salts of the type described above.

In the case of compositions whose supported phase contains a rare earth, it may be advantageous to deposit the rare earth first and then the manganese.

According to a third embodiment of the NOx trap which is the object of the present invention, there can be used as composition to make the NOx trap two compositions whose active phases are based on manganese and another element chosen from among the alkali metals, the alkaline earths and the rare earths and its use in the treatment of exhaust gases.

The object of this third embodiment of the invention is therefore the development of a compound that can be used in a broader temperature range and if necessary without precious metal.

To this end, the composition according to the object of the invention that can be used as a NOx trap is characterized in that it comprises an association:

of a first composition comprising a support and an active phase, wherein the active phase is based on manganese and at least one other element A chosen from among the alkali metals and the alkaline earths, and the manganese and element A are chemically bonded;

of a second composition comprising a support and an active phase based on manganese and at least one other element B chosen from among the alkali metals, the alkaline earths and the rare earths, wherein this second composition has or is capable of having a specific surface area of at least 80 m²/g after 8 hours of calcining at 800° C.

The composition according to the object of the third embodiment is characterized by the association of two specific compositions, which will now be described more particularly.

These compositions comprise a support and an active phase with the meanings given previously. The first composition is described hereinbelow.

This composition comprises an active phase based on manganese and at least one other element A chosen from among the alkali metals and the alkaline earths. As alkali metal there can be cited more particularly sodium and potassium. As alkaline earth element there can be mentioned in particular barium. Since the composition can contain one or more elements A, any reference to element A in the description hereinafter is therefore to be understood as also being applicable to the case in which a plurality of elements A is present.

In addition, the elements manganese and A are present in this first composition in a chemically bonded form. By this it is understood that chemical bonds exist between the manganese and element A as a result of a reaction between them, wherein these two elements are not simply present together as in a simple mixture. Thus the elements manganese and A can be present in the form of a compound or of a phase of the mixed oxide type. This compound or this phase can be represented especially by the formula AₓMn_{y}O_{2-d} (1), wherein 0.5<y/x<6. As the phase or compound of formula (1) there can be cited as examples those of the vernadite, hollandite, romanechite or psilomelane, birnessite, todorokite, buserite or lithiophorite type. The compound may be hydrated if appropriate. The compound may also have a layer structure of CdI₂ type. Formula (1) is given here by way of illustration, but it would not be a departure from the scope of the present invention if the compound were to have a different formula provided, of course, that the manganese and element A are indeed chemically bonded.

The presence of such a compound can be detected by X-ray analysis or electron microscopy.

The oxidation number of the manganese may vary between 2 and 7, more particularly between 3 and 7.

In the case of potassium, this element and the manganese may be present in the form of a compound of K₂Mn₄O₈ type. In the case of barium, it may be a compound of the BaMnO₃ type.

The first composition additionally comprises a support. As support there can be employed any porous support that can be used in the art of catalysis. It is preferable that this support have chemical inertia with respect to the elements manganese and A that is sufficient to prevent a substantial reaction of one or both of these elements with the support and which could interfere with the formation of a chemical bond between manganese and element A. Nevertheless, in the event of a reaction between the support and these elements, it is possible to employ larger quantities of manganese and element A to obtain the desired chemical bonding between these elements.

More particularly, the support is based on an oxide chosen from among cerium oxide, zirconium oxide or mixtures thereof.

For the mixtures of cerium oxide and zirconium oxide there can be mentioned especially those described in European Patent Applications EP A 605274 and EP A 735984, the content of which is incorporated here. There can also be used more particularly the supports based on cerium oxide and zirconium oxide in which these oxides are present in a cerium/zirconium atomic ratio of at least 1. For these same supports, there can also be used those having the form of a solid solution. In this case, the X-ray diffraction spectra of the support reveal the existence of a single homogeneous phase in the body of this support. For the supports richest in cerium, this phase corresponds in fact to that of a crystalline cubic ceric oxide, CeO₂, whose lattice parameters deviate above or below those of a pure ceric oxide, thus reflecting the incorporation of zirconium into the crystal structure of cerium oxide, and thus the formation of a true solid solution.

There can also be mentioned for the mixtures cerium oxide and zirconium oxide based on these two oxides and furthermore scandium oxide or an oxide of a rare earth other than cerium, and especially those described in International Patent Application WO 97/43214, the content of which is incorporated here. That application describes in particular compositions based on an oxide of cerium, an oxide of zirconium and an oxide of yttrium, or else, in addition to the oxide of cerium and the oxide of zirconium, based on at least one other oxide chosen from among the oxide of scandium and the oxides of rare earth with the exception of cerium, in a cerium/zirconium atomic ratio of at least 1. These compositions have a specific surface area of at least 35 m²/g after 6 hours of calcining at 900° C. and an oxygen storage capacity at 400° C. of at least 1.5 ml O₂/g.

According to an alternative version of this third embodiment of the invention, the support is based on cerium oxide and in addition it contains silica. Supports of this type are described in European Patent Applications EP A 207857 and EP A 547924, the content of which is incorporated here.

The total content of manganese, alkali metal and alkaline earth can be varied within broad proportions. The minimal proportion is that beyond which NOx-adsorption activity is no longer observed. This content can range in particular between 2 and 50%, more particularly between 5 and 30%, wherein this content is expressed in % atomic relative to the sum of the moles of oxide(s) of the support and of the elements in question of the active phase. The respective contents of manganese, alkali metal and alkaline earth can also be varied within broad proportions, and the manganese content can in particular be equal or close to that of the alkali metal or alkaline earth.

The first composition of the compound which is the object of the third embodiment of the invention can be prepared by a process in which the support is brought into contact with the manganese and at least one other element A or with the precursors of manganese and of at least one other element A, and in which the whole is calcined at a temperature sufficient to create a chemical bond between the manganese and element A.

A method that can be used for the aforesaid operation of bringing into contact is impregnation. As an example, a solution or a slip of salts or compounds of the elements of the supported phase is formed first of all.

As examples of salts, there can be chosen the salts of inorganic acids, such as the nitrates, the sulfates or the chlorides.

There can also be used the salts of organic acids, and especially the salts of saturated aliphatic carboxylic acids or the salts of hydroxycarboxylic acids. As examples, there can be cited the formates, acetates, propionates, oxalates or citrates.

The support is then impregnated with the solution or the slip.

Dry impregnation is used more particularly. In dry impregnation, a volume of an aqueous solution of the element equal to the pore volume of the solid to be impregnated is added to the product to be impregnated.

It may be advantageous to perform deposition of the elements of the active phase in two stages. Thus the manganese can be advantageously deposited in a first stage and then element A in a second stage.

After impregnation, the support is dried if necessary and then calcined. It must be noted that it is possible to use a support that has not yet been calcined prior to impregnation.

Deposition of the active phase can also be performed by atomization of a suspension based on salts or compounds of the elements of the active phase and of the support. The atomized product obtained in this way is then calcined.

As indicated above, calcining is performed at a temperature sufficient to create a chemical bond between the manganese and element A. This temperature varies according to the nature of element A but, in the case of calcining under air, it is generally at least 600° C., more particularly at least 700° C. and especially it can range between 800° C. and 850° C. Higher temperatures are generally not necessary, inasmuch as the chemical bond between the manganese and element A is already formed, while on the other hand they can lead to a reduction of the specific surface area of the support, which in turn can reduce the catalytic properties of the composition. The calcining time depends especially on the temperature, and it is also fixed in such a way as to be sufficient to create chemical bonding of the elements.

The second composition of the compound which is the object of the third embodiment of the invention will now be described.

This composition also contains a support and an active phase.

What has been said above on the subject of the active phase of the first composition is also applicable here, especially as regards the nature and quantity of the elements of this phase. Thus element B can be more particularly sodium, potassium or barium.

The active phase of the second composition can also be based on manganese and at least one rare earth. That rare earth can be chosen more particularly from among cerium, terbium, gadolinium, samarium, neodymium and praseodymium. The total content of manganese, alkali metal, alkaline earth or rare earth can be varied between 1 and 50%, more particularly between 5 and 30%. This content is expressed in % atomic relative to the sum of the moles of oxide(s) of the support and of the elements in question of the supported phase. The respective contents of manganese, alkali metal, alkaline earth or rare earths can also be varied within broad proportions, and the manganese content can in particular be equal or close to that of element B.

As indicated above, a characteristic of the second composition is that it has or is capable of having a specific surface area of at least 80 m²/g after 8 hours of calcining at 800° C. More particularly, this specific surface area is at least 100 m²/g after 8 hours of calcining at 800° C.

This surface area characteristic is obtained by choosing a suitable support, especially having a sufficiently large specific surface area.

This support can be based on alumina. There can be used here any type of alumina capable of having a specific surface area sufficient for application in catalysis. There can be mentioned the aluminas obtained from rapid dehydration of at least one aluminum hydroxide, such as bayerite, hydrargillite or gibbsite, nordstrandite, and/or at least one aluminum oxyhydroxide such as boehmite, pseudoboehmite and diaspore.

According to an alternative embodiment, there is used a stabilized alumina. As stabilizing element there can be cited the rare earths, barium, silicon and zirconium. As rare earth there can be mentioned very particularly cerium, lanthanum or the lanthanum-neodymium mixture.

The stabilized alumina is prepared in a manner known in itself, especially by impregnation of the alumina with solutions of salts, such as the nitrates, the aforesaid stabilizing elements or else by drying an alumina precursor and salts of these elements together, followed by calcining.

There can also be cited another preparation of stabilized alumina in which the alumina powder obtained from rapid dehydration of an aluminum hydroxide or oxyhydroxide is subjected to an aging operation in the presence of a stabilizing agent comprising a lanthanum compound and if necessary a neodymium compound, wherein this compound can be more particularly a salt. Aging can be achieved by suspending the alumina in water then heating to a temperature of, for example, between 70 and 110° C. After aging, the alumina is subjected to a heat treatment.

Another preparation comprises a similar type of treatment, but using barium.

The content of stabilizer expressed in weight of stabilizing oxide relative to the stabilized alumina generally ranges between 1.5 and 15%, more particularly between 2.5 and 11%.

The support may also be based on silica.

It may also be based on silica and titanium oxide in a Ti/Ti+Si atomic ratio of between 0.1 and 15%. This proportion may range more particularly between 0.1 and 10%. Such a support is described especially in International Patent Application WO 99/01216, the content of which is incorporated here.

As another appropriate support there can be used those based on cerium oxide and zirconium oxide, wherein these oxides can have the form of a mixed oxide or of a solid solution of zirconium oxide in cerium oxide or vice versa. These supports are obtained by a first type of process which comprises a stage in which a mixture comprising zirconium oxide and cerium oxide is formed and the mixture formed in this way is washed or impregnated by an alkoxylated compound having a number of carbon atoms greater than 2. The impregnated mixture is then calcined.

The alkoxylated compound can be chosen in particular among the products of formula (2), R₁—((CH₂)_{X}—O)ₙ—R₂, in which R₁ and R₂ represent alkyl groups which may or may not have straight chains, or H or OH or Cl or Br or I; n is a number between 1 and 100; and x is a number between 1 and 4, or else those of formula (3), (R₃,R₄)—v—((CH₂)ₓ—O)ₙ—OH, in which v denotes a benzene ring, R₃ and R₄ are identical or different substituents of this ring and represent hydrogen or alkyl groups which may or may not have straight chains and have 1 to 20 carbon atoms, x and n being defined as previously; or else those of formula (4), R₄O—((CH₂)ₓ—O)ₙ—H, where R₄ represents an alcohol group which may or may not have straight chains and has 1 to 20 carbon atoms; x and n being defined as previously; and those of formula (5), R₅—S—((CH₂)ₓ—O)ₙ—H, where R₅ represents an alkyl group which may or may not have straight chains and has 1 to 20 carbon atoms, x and n being defined as previously. For these products reference may be made to International Patent Application WO 98/16472, the content of which is incorporated here.

These supports can also be obtained by a second type of process, which comprises a stage in which there are reacted a solution of a cerium salt, a solution of a zirconium salt and an additive chosen from among the anionic surfactants, the nonionic surfactants, the polyethylene glycols, the carboxylic acids and their salts, wherein the reaction can take place if necessary in the presence of a base and/or of an oxidizing agent.

As anionic surfactants there can be used more particularly the carboxylates, the phosphates, the sulfates and the sulfonates. Among the nonionic surfactants there can be used preferably the ethoxylated alkylphenols and the ethoxylated amines.

The reaction between the zirconium and cerium salts can be achieved by heating the solution containing the salts, in which case it is a thermohydrolysis reaction. It can also be achieved by precipitation, by introducing a base into the solution containing the salts.

For these products reference may be made to International Patent Application WO 98/45212, the content of which is incorporated here.

The second composition can be prepared with the same methods as those given above for the first. It will be noted that, after the support has been brought into contact with the elements of the active phase, the whole is calcined at a temperature sufficient to ensure that these elements are present in the form of oxides. In general, this temperature is at least 500° C., more particularly at least 600° C.

The compound of the invention such as described hereinabove has the form of a powder, but it can also be processed if necessary in such a way that it has the form of granules, balls, cylinders or honeycombs of variable dimensions.

According to an alternative version, the NOx trap according to the third embodiment comprises a substrate and a coating constituted by two superposed layers. In this case, the first layer contains the first composition of the compound and the second layer contains the second composition. The order of the layers is optional, meaning that the internal layer in contact with the substrate may contain either the first or the second composition, the external layer deposited on the first layer then containing the other composition of the compound.

According to another alternative version, the compound is present in the coating in the form of a single layer, which in this case comprises the two aforesaid compositions in the form of a mixture, which is obtained, for example, by mechanical mixing.

Yet another alternative version can also be envisioned. In this case, the NOx trap comprises two substrates side-by-side, each substrate comprising a coating. The coating of the first substrate contains the first composition and the coating of the second substrate contains the second composition.

Thus, by virtue of the different embodiments described hereinabove, NOx trap 3 is completely devoid of precious metals and thus offers no catalytic reduction capacity (or extremely reduced capacity). The assembly of NOx trap 3 and trifunctional catalyst 4 is therefore less expensive to manufacture than the NOx traps impregnated with known catalysts. In addition, in the absence of precious metals and of catalytic capacity, the NOx trap made in this way has particularly surprising resistance to sulfur poisoning.

Of course, the invention is in no way limited to the described and illustrated embodiments, which have been given merely by way of examples.

To the contrary, the invention includes all technical equivalents of the described means as well as their combinations achieved in accordance with the spirit thereof.

1. A device for purification of the exhaust gases of an internal combustion engine comprising an internal combustion engine capable of achieving combustion of a fuel with lean air-fuel ratios, NOx-adsorbing means installed in the exhaust line of the engine, the said means being of the type that adsorb the NOx present in the exhaust gases in the presence of excess oxygen and that release the adsorbed NOx when the oxygen concentration of the exhaust gases decreases, characterized in that, on the one hand, the NOx-adsorbing means do not contain any composition capable of acting as NOx reduction catalyst, and especially no precious metal, and in that, on the other hand, a three-way catalyst is installed in the exhaust line downstream from the NOx-adsorbing means.

2. A device for purification of the exhaust gases of an internal combustion engine according to claim 1, characterized in that the NOx-adsorbing means contain a support based on an oxide chosen from among the oxides of cerium, zirconium, scandium or rare earths, and an active phase based on manganese.

3. A device for purification of the exhaust gases of an internal combustion engine according to claim 2, characterized in that the Nox-adsorbing means contain an active phase based on manganese and at least one other element chosen from among the alkali metals, the alkaline earths and the rare earths.

4. A device for purification of the exhaust gases of an internal combustion engine according to claim 3, characterized in that the other element is chosen from among the alkali metals and the alkaline earths, wherein the alkali metal can be more particularly potassium and the alkaline earth can be more particularly barium.

5. A device for purification of the exhaust gases of an internal combustion engine according to claim 3, characterized in that the other element is chosen from among the rare earths.

6. A device for purification of the exhaust gases of an internal combustion engine according to any one of claims 2 to 5, characterized in that the NOx-adsorbing means contain an active phase based on manganese and at least one other element chosen from among terbium, gadolinium, europium, samarium, neodymium and praseodymium.

7. A device for purification of the exhaust gases of an internal combustion engine according to any one of claims 2 to 6, characterized in that the NOx-adsorbing means contain a support based on an oxide of cerium, an oxide of zirconium and an oxide of scandium or of rare earths.

8. A device for purification of the exhaust gases of an internal combustion engine according to claim 7, characterized in that the cerium/zirconium atomic ratio in the support is at least 1.

9. A device for purification of the exhaust gases of an internal combustion engine according to any one of claims 2 to 8, characterized in that the support has a specific surface area of at least 40 m²/g after 6 hours of calcining at 900° C.

10. A device for purification of the exhaust gases of an internal combustion engine according to any one of claims 2 to 9, characterized in that the support is represented by the formula CeₓZr_{y}M_{z}O₂, where M represents at least one element chosen from among the group comprising scandium and the rare earths other than cerium, and where 0<z<0.31 and more particularly 0.019<z<0.021, and 0.9<x/y<20 and more particularly 0.9<x/y<10, and x, y and z are related by the condition x+y+z=1.

11. A device for purification of the exhaust gases of an internal combustion engine according to any one of claims 2 to 10, characterized in that the rare earth present in the composition of the support is lanthanum, neodymium or praseodymium.

12. A device for purification of the exhaust gases of an internal combustion engine according to any one of claims 2 to 10, characterized in that the NOx-adsorbing means comprise the association of two distinct compositions; a first composition comprising a support and an active phase, wherein the active phase is based on manganese and at least one other element A chosen from among the alkali metals and the alkaline earths, and the manganese and element A are chemically bonded; and a second composition comprising a support and an active phase based on manganese and at least one other element B chosen from among the alkali metals, the alkaline earths and the rare earths, wherein this second composition has or is capable of having a specific surface area of at least 80 m²/g after 8 hours of calcining at 800° C.

13. A device for purification of the exhaust gases of an internal combustion engine according to claim 12, characterized in that the second composition has or is capable of having a specific surface area of at least 100 m²/g after 8 hours of calcining at 800° C.

14. A device for purification of the exhaust gases of an internal combustion engine according to any one of claims 12 to 13, characterized in that elements A and B are chosen from among potassium, sodium or barium.

15. A device for purification of the exhaust gases of an internal combustion engine according to any one of claims 12 to 14, characterized in that the support of the second composition is based on alumina or on alumina stabilized by silicon, zirconium, barium or a rare earth.

16. A device for purification of the exhaust gases of an internal combustion engine according to any one of claims 12 to 14, characterized in that the support of the second composition is based on silica.

17. A device for purification of the exhaust gases of an internal combustion engine according to any one of claims 12 to 14, characterized in that the support of the second composition is based on silica and titanium oxide in a Ti/Ti+Si atomic ratio of between 0.1 and 15%.

18. A device for purification of the exhaust gases of an internal combustion engine according to any one of claims 12 to 14, characterized in that the support of the second composition is based on cerium oxide and zirconium oxide, wherein this support has been obtained by a process in which a mixture comprising zirconium oxide and cerium oxide is formed and the mixture formed in this way is washed or impregnated by an alkoxylated compound having a number of carbon atoms greater than 2.

19. A device for purification of the exhaust gases of an internal combustion engine according to any one of claims 12 to 14, characterized in that the support of the second composition is based on cerium oxide and zirconium oxide, wherein this support has been obtained by a process in which there are reacted a solution of a cerium salt, a solution of a zirconium salt and an additive chosen from among the anionic surfactants, the nonionic surfactants, the polyethylene glycols, the carboxylic acids and their salts, and wherein the reaction can take place if necessary in the presence of a base and/or of an oxidizing agent.
